(19) United States
(12) Patent Application Publication
(10) Pub. No.: US 2002/0108016 A1
(43) Pub. Date: Aug. 8, 2002

(54) System for characterizing performance of data handling systems under particular stimuli

(75) Inventors: Jonathan Williams Haines, Lafayette, CO (US); Nathan Scott Abelein, Berthoud, CO (US); Jack William Lakey, Boulder, CO (US); Henry Elwood Davenport, Longmont, CO (US)

Correspondence Address: MERCHANT & GOULD P.C., P.O. Box 2903, Minneapolis, MN, 55402-0903, US

(73) Assignee: Seagate Technology LLC

(21) Appl. No.: 09/778,130

(22) Filed: Feb. 6, 2001

Related U.S. Application Data
(60) Provisional application No. 60/255,357, filed on Dec. 13, 2000.

(51) Int. Cl. G06F 12/00

(52) U.S. Cl. 711/112; 711/118

(57) ABSTRACT

A system and method for characterizing performance of a data handling system, such as a disc drive or computer network, is disclosed. The system includes a host computer for issuing commands for data blocks that are large enough to neutralize caching schemes that may otherwise mask the worst-case performance of the data handling system. Block service times for the commands are recorded and are compared to a maximum allowable service time threshold. This comparison is then used to generate a performance score for the data handling system. Other parameters may also be factored into the performance score such as the frequency and size of data quality errors.

### RELATED APPLICATIONS

This application claims priority of U.S. provisional application Serial No. 60/255,357, filed Dec. 13, 2000.

### FIELD OF THE INVENTION

This application relates generally to performance characterization for data handling systems such as disc drives and networks and more particularly to a system for characterizing performance of data handling systems under particular stimuli such as writing data blocks of a given size and location to a disc.

### BACKGROUND OF THE INVENTION

Performance characterization for data handling systems is used to determine the data handling systems' abilities to perform well under given circumstances. Conventional performance characterization systems have attempted to measure an average performance of a data handling system, as average performance may be representative of some real world applications. However, many applications require that the data handling system have a performance that remains at least at a certain minimum level over a given interval, and the application gains little or no benefit from performance above that minimum level at any time or on average. These applications may suffer greatly from performance that drops below the minimum level. Thus, average performance is not a meaningful measure of the data handling system's ability to cope with applications presenting situations where performance cannot occasionally lag.

A personal video recorder (PVR) using hard disc storage is an example of a data handling system that must have a worst-case performance that meets or exceeds a minimum performance level. The audio-visual data that must be handled is generally time critical and must be written to the disc or read from the disc at least at a minimum rate to provide satisfactory audio-visual storage and playback. An average performance measurement will not be a satisfactory measure of the system's performance because the system may have a worst-case performance level that occasionally dips below the minimum level that remains satisfactory for the audio-visual application. A drop in performance below the minimum level may result in audio-visual data being inadequately stored and/or played back, which results in errors that are easily perceivable by the end user.

The conventional performance characterization systems typically measure average performance of audio-visual data handling systems by detecting the rate at which data can be provided to or taken from the host during ordinary operation. The audio-visual data handling system can utilize caching to present or receive a steady flow of data to/from a host computer, even though the data handling system is providing or receiving data to/from its buffer at rates that fluctuate well above or below the rate at which data is being paced between the buffer and the host. However, if the audio-visual data handling system that is utilizing such a caching scheme is presented with a worst-case situation rather than an average (i.e., non-worst-case) operation, the audio-visual data handling system must continue to provide data to the host at a level at or above the minimum required for the audio-visual application to have satisfactory performance. Conventional performance characterization systems do not present such worst-case situations.

A worst-case situation may arise where read/write retries involving additional disc revolutions are required. The retries may cause the rate at which data is written to or read from the storage disc to drastically decrease. If during a write operation the buffer is full, it cannot receive data from the host any faster than the audio-visual data handling system can pass data to the storage disc, and the retries cause the rate at which data is taken from the host to drop dramatically. If during a read operation the buffer is empty, it cannot provide data to the host any faster than the audio-visual data handling system can take data from the storage disc, and the retries cause the rate data is provided to the host to drop dramatically. The conventional performance characterization systems that find average performance do not measure the audio-visual data handling system's worst-case performance and therefore, cannot determine whether the audio-visual data handling system will meet or exceed the required minimum level of performance for all potential situations.

Accordingly there is a need for a system that can characterize the performance of a data handling system for applications including those where the worst-case performance must be at or above a given level.

### SUMMARY OF THE INVENTION

Against this backdrop the present invention has been developed. The present invention provides a system for characterizing the performance of a data handling system including its worst-case performance.

The invention may be viewed as a method for characterizing performance of a data handling system having a cache. The method involves sending commands to the data handling system for a set of data blocks that are large relative to the size of the cache dedicated for the commands. A block service time for each large data block is recorded. The block service time is compared to a first threshold. The data handling system is scored based on the comparison of the block service time to the first threshold.

The invention may also be viewed as a system for characterizing performance of a data handling system having a cache. The system includes a host computer for providing commands that are serviced by the data handling system. The host computer is configured to send commands to the data handling system for a set of data blocks that is large relative to the size of the cache dedicated for the commands. The host computer is also configured to record a block service time for each large data block and to compare the block service time to a first threshold. The host computer scores the data handling system based on the comparison of the block service time to the first threshold. An interface is also included for communicating the commands from the host computer to the data handling system.

These and various other features as well as advantages which characterize the present invention will be apparent from a reading of the following detailed description and a review of the associated drawings.

### BRIEF DESCRIPTION OF THE DRAWINGS

FIG. 1 is a plan view of the primary internal components of a disc drive data handling system whose performance may be characterized by embodiments of the present invention.

FIG. 2 is a functional block diagram of the disc drive control of the disc drive data handling system shown in FIG. 1.

FIG. 3 is a flow diagram illustrating the operational sequence of a performance characterization process in accordance with a preferred embodiment of the present invention.

FIG. 4 is an exemplary histogram utilized in accordance with a preferred embodiment of the present invention.

### DETAILED DESCRIPTION

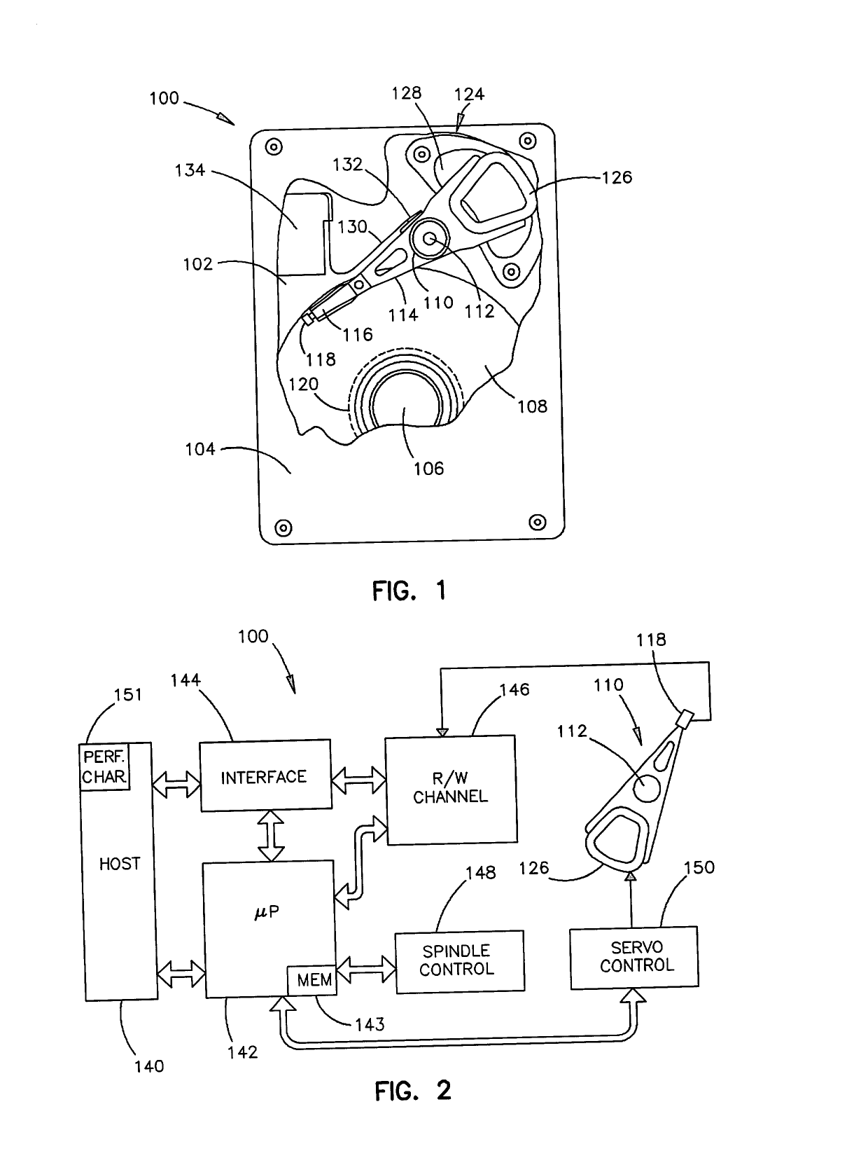

A disc drive 100 that may form a part of a data handling system to be characterized by an embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106 which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a transducer head 118 which includes an air bearing slider enabling the head 118 to fly in close proximity above the corresponding surface of the associated disc 108.

During a seek operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well known Lorentz relationship. As the coil 126 moves, the actuator assembly 110 pivots about the bearing shaft assembly 112, and the heads 118 are caused to move across the surfaces of the discs 108.

A flex assembly 130 provides the requisite electrical connection paths for the actuator assembly 110 while allowing pivotal movement of the actuator assembly 110 during operation. The flex assembly includes a preamplifier printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100.

Referring now to FIG. 2, shown therein is a functional block diagram of the disc drive 100 of FIG. 1 interfaced to a host computer 140. FIG. 2 generally shows the main functional circuits which are resident on the disc drive printed circuit board and used to control the operation of the disc drive 100. The disc drive 100 is operably connected to the host computer 140 in a conventional manner, and the host computer 140 typically implements an embodiment of the performance characterization system 151 as is discussed below. Control communication paths are provided between the host computer 140 and an interface 144 that typically channels the control communication to a disc drive microprocessor 142, the microprocessor 142 generally providing top level communication and control for the disc drive 100 in conjunction with programming for the microprocessor 142 stored in microprocessor memory (MEM) 143. The MEM 143 can include random access memory (RAM), read only memory (ROM) and other sources of resident memory for the microprocessor 142.

The discs 108 are rotated at a constant high speed by a spindle motor control circuit 148, which typically electrically commutates the spindle motor 106 (FIG. 1) through the use of back electromotive force (BEMF) sensing. During a seek operation, wherein the actuator 110 moves the heads 118 between tracks, the position of the heads 118 is controlled through the application of current to the coil 126 of the voice coil motor 124. A servo control circuit 150 provides such control. During a seek operation the microprocessor 142 receives information regarding the velocity of the head 118, and uses that information in conjunction with a velocity profile stored in memory 143 to communicate with the servo control circuit 150, which will apply a controlled amount of current to the voice coil motor coil 126, thereby causing the actuator assembly 110 to be pivoted.

Data is transferred between the host computer 140 or other device and the disc drive 100 by way of the interface 144, which typically includes a buffer to facilitate high speed data transfer between the host computer 140 or other device and the disc drive 100. The buffer operates as a cache that can be used to pace data received from or provided to the host computer 140. Data to be written to the disc drive 100 is thus passed from the host computer 140 to the interface 144 and then to a read/write channel 146, which encodes and serializes the data and provides the requisite write current signals to the heads 118. To retrieve data that has been previously stored in the disc drive 100, read signals are generated by the heads 118 and provided to the read/write channel 146, which performs decoding and error detection and correction operations and outputs the retrieved data to the interface 144 for subsequent transfer to the host computer 140 or other device. Such operations of the disc drive 100 are well known in the art and are discussed, for example, in U.S. Pat. No. 5,276,662 issued Jan. 4, 1994 to Shaver et al.

The performance characterization system 151 in accordance with the present invention implements a testing procedure typically performed by the host computer 140 to determine the performance of the data handling system, such as disc drive 100. The data handling system may take other forms as well. The data handling system may be a data transmission system in a network environment, such as the Internet, where data is passed through a network medium from one host computer 140 to another. In either the disc drive or network data handling systems, retries may occur where attempts must be made to re-read/write (re-transmit for networks) data where previous attempts to read/write (transmit) the same data have failed.

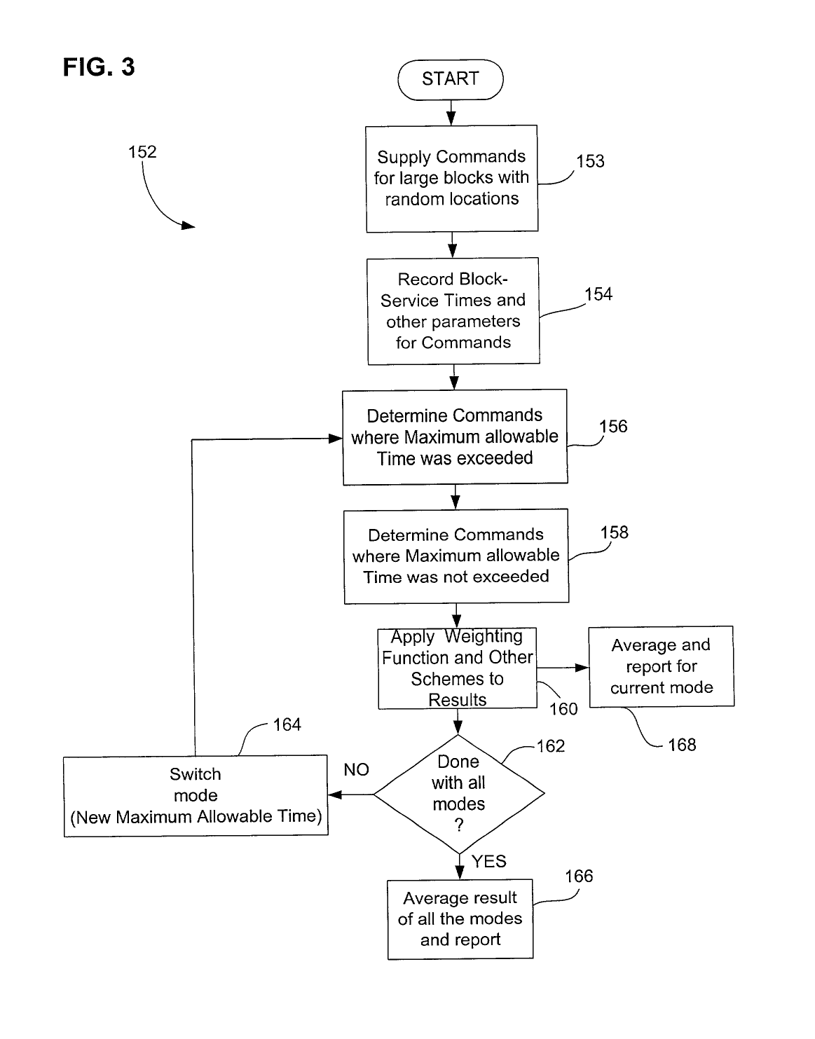

The performance characterization procedure 152 is illustrated in FIG. 3. The process begins at Command operation 153 where commands are supplied from the host computer 140 to the disc drive 100 to cause the disc drive 100 to attempt to read or write large blocks of data to the drive. Typically, the number of Bytes per command are limited so several commands may need to be issued for a single large block of data. The size for the block of data is chosen to be large relative to the size of the cache available to the hard disc 100. A block of data is large relative to the size of the cache dedicated for passing data for the block such as when the block size is greater than or equal to the size of the cache being used to exchange the data block between the disc 108 and host 140 or when the block size is large enough to cause the cache to be unable to otherwise mask the worst-case performance of the disc drive 100. The large blocks of data that are requested may be provided such that their location on the disc 108 is randomized.

Generating commands for large blocks of data, where each block in the sequence has a location that is random relative to a previous block, prevents the disc drive from performing caching read-ahead techniques to mask worst-case performance. The large block size causes write caching to be neutralized because the cache cannot effectively support multiple large blocks of data. Together, large randomized blocks allow mechanical movements of the disc drive 100 to dominate, during reads or writes, the block service time which ultimately is a measure of the data rate and the seek and transfer times.

The host 140 may issue commands to the disc drive 100 in a manner such that the drive 100 is instructed to perform in a given manner. For example, the host 140 may instruct the drive 100 to read or write data while maintaining throughput as a priority rather than data integrity. The host 140 may also instruct the drive 100 to read or write data while maintaining the integrity of the data as a priority rather than throughput. The host 140 may alternatively issue commands so that a variable quality of the transferred data is permissible so that a reasonable degree of data integrity is maintained while throughput is maximized.

After the commands for large randomized blocks have been provided by the host 140 at Command operation 153, the host 140 begins to record the block service times as the disc drive 100 begins to read or write the data to the disc 108 at Record operation 154. The block service time is effectively the amount of time required by the disc drive 100 to take the data for a given block from the host 140 or provide the data for a given block to the host 140. Other parameters may be obtained by the host 140 during Block operation 154 such as generating an estimate of the minimum and maximum sustainable data rates from sequential read or write testing of very long data sets, or from the various block service times being recorded during the randomly-located, large block commands. The sustainable data rate as estimated at this operation 154 allows an assumption of the disc drive's ability to parse a command and pass data between the disc 108 and the buffer and between the buffer and the host 140. Additional parameters obtained during Record operation 154 by the host 140 may include the number and size of data quality errors that are generated for each command. Additionally, during Record operation 154, the host 140 may record the frequency of the data quality errors.

Generally, during the block service time, the drive 100 is required to perform several tasks. These include parsing the command to decide what it requires the drive to do, seeking to the correct location on the disk, waiting for the disc to rotate to the correct position, track following using the servo system, and passing data between the head 118 and the buffer and between the buffer and the host 140. The host 140 may set up performance characterization tests where one or more of these tasks are not applicable, but generally each will be required of the drive 100 to fully handle the issued command.

After the drive 100 has finished servicing each command presented by the host 140, the host 140 may determine where the maximum allowable time for each block was exceeded at High operation 156. Each instance where the drive exceed the maximum allowable time presents an instance where an end user may notice an error by the data handling system, especially in the audio-visual data handling system such as a PVR. The maximum allowable time that is used as a threshold by the performance characterization system 151 is known from the mode of operation of the data handling system. For example, in one mode a PVR may be concurrently operating on 3 standard definition television (SDTV) data streams each having a 15Mb/s rate and a total of 4MB allocated per stream. Assuming the PVR uses double-buffering (though many other buffering schemes are possible) for a stream to allocate half of the buffer to be written to at a time and half to be read from at that same time, then it is necessary to know the maximum service time available for a 2MB block. The maximum allowable service time for this block is computed as lo follows:

2MB per block for a stream/(3 streams*15Mb/s per stream/8b/B)=0.355 seconds per 2MB block

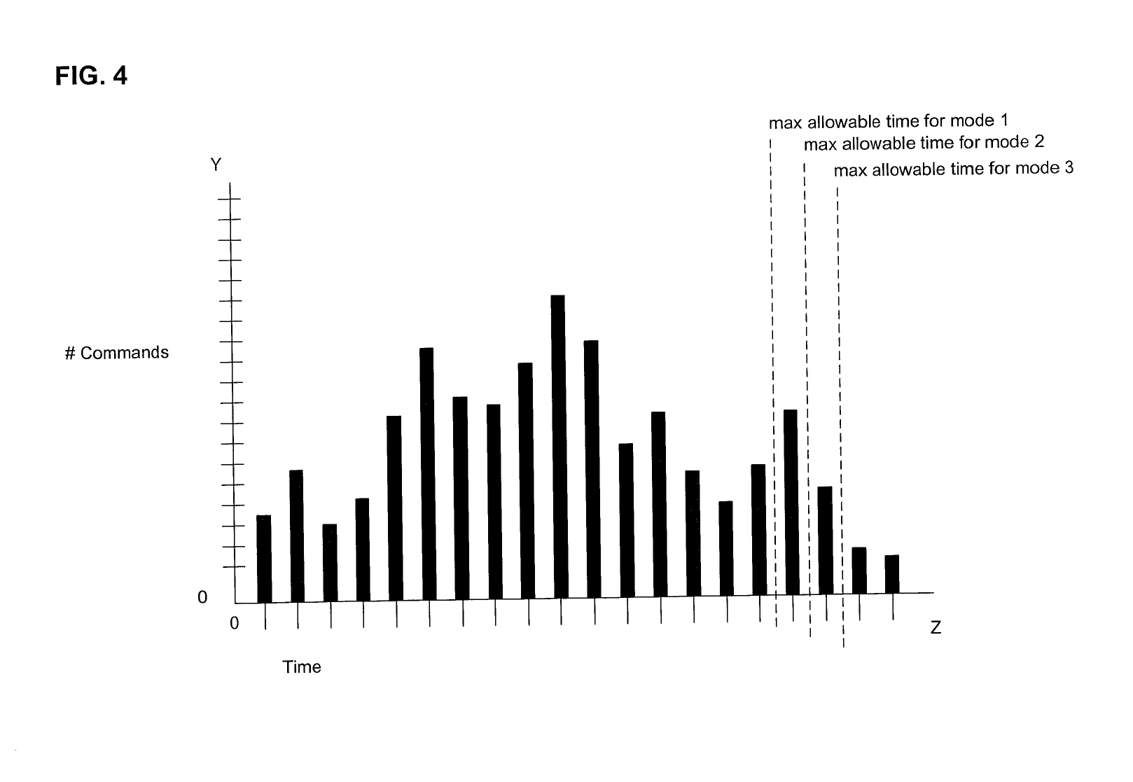

Thus, for the mode described above, the threshold for each block service time is 0.355 seconds. The host 140 implementing the performance characterization system 151 may then compare the block service time it has recorded against the 0.355 seconds to determine the number of commands that exceeded the threshold for acceptable performance. The host 140 may create a histogram of all block service times for each command, as is discussed below with reference to FIG. 4.

The host 140 may also determine the number of commands that were executed by the drive 100 in less time than the threshold at Low operation 158. These commands indicate instances where the drive 100 exceeded the performance necessary for the given mode. The drive's ability to significantly exceed the minimum performance level may or may not be beneficial for the given data handling system application. In the PVR case, exceeding the minimum threshold may be beneficial in that the host 140 can fill this performance capacity with other, non-audio-visual work. For example, the PVR may read menu data from the disc drive in response to a user selection or it may write web pages to the disc drive that it estimates the user may choose to view in the future. This may provide a non-audio-visual performance increase by allowing the drive's caching schemes to provide better assistance during non-worst-case instances.

In High and Low operations 156 and 158, the host 140 may attempt to estimate particular locations of the data on the disc, such as radially, rotationally, or a combination of both, based on where the drive placed or accessed the data during the Record operation 154. The host 140 may determine where a given logical block address range is physically located on the disc and thus know where the drive is more or less susceptible to having quality failures due to excessive overhead time. Thus, from determining the number of commands that resulted in a service time beyond the maximum allowed and by knowing where that data was placed on the disc, the host 140 may determine how much of the drive meets the maximum allowed service time limitation and may learn where data should be placed when the time limitation is more critical.

After the host 140 has determined which commands were executed in an amount of time greater than or less than the threshold, a weighting function may be applied to the determination at Results operation 160. Here, it may be chosen to weight the block service times according to a scheme that allows the drive's advantages and disadvantages to be more clearly illustrated for a given application. For example, in the PVR case, the number of instances where the drive 100 exceeded the threshold may be heavily weighted negatively since exceeding the threshold often means the end user will perceive an error. In that case, the instances where the drive 100 executed commands in less time than the threshold may be slightly positively weighted. The weighted values may then be averaged to present a score for the given mode. The average for the mode may be reported by the host 140 at Report operation 168 such as by providing a visual display or print out.

Results operation 160 may also include other factors in the ultimate score for the drive 100 in a given mode. For example, it may be an important factor that the drive provided data with a frequency of errors, as previously determined, under a particular threshold. Similar scoring and weighting principles may be applied to permit this factor to affect the score. The size of the data errors may also be compared to a selected threshold and scoring and weighting principles may be applied to this factor, which can affect the score. Furthermore, Results operation 160 may treat data quality errors as good data that was delivered after the threshold to enable a characterization of the drive 100 that more equally values time and quality performance. This allows drives 100 emphasizing quality to be compared to drives 100 that emphasize throughput.

Furthermore, Results operation 160 may characterize the system for command sizes different than the command size used to generate each large block at Command operation 153. The time label on each bin of the histogram may be adjusted, possibly in a non-uniform manner to account for varying data rates, to provide an approximation of the drive's response to smaller command sizes. Using the estimated minimum and maximum sustainable data rates previously determined, linear amounts could be removed from each bin time value to readjust the histogram to approximate the response to smaller block sizes. The histogram will have roughly the same shape but will become more compact on the time axis due to the smaller block sizes requiring less time. A new threshold time may be computed for the smaller block size by substituting the new block size value in the equation noted above. Thus, worst-case performance may be approximated for small blocks from the block service times recorded for large blocks, which were utilized to avoid caching schemes that may otherwise mask worst-case performance for small blocks.

In the embodiment shown, after the average for the given mode is reported at Report operation 168, query operation 162 detects whether other modes for the drive 100 should be tested. If so, then control returns to High operation 156 where it is again determined from the previously recorded block service times whether the drive 100 has exceeded the maximum allowable time for any commands for the new mode. The new mode may differ from the previous mode such as by the number of streams to be concurrently handled, by the rate at which a given stream will provide or require data, and possibly by the block size as discussed above. A new maximum allowable time is determined and applied at High operation 156 and Low operation 158 based on the new mode of operation. Thus, performance for various modes of operation (i.e., workloads) can be determined from the block service times recorded from a single instance of Command operation 153.

If query operation 168 detects that no other modes need to be tested, then Average operation 166 may average the scores for each mode tested and report an overall score for the drive 100. The overall score maybe beneficial in determining which drive 100 will be best suited to use across several different modes of operation. The score reported at Report operation 168 may be useful for determining which drive 100 is best suited for any one particular mode of operation.

FIG. 4 shows an exemplary histogram 170 that may be created by the host 140 for analysis. The histogram 170 shows that the amount of time to service a data block of a given size varies, as shown from 0 to Z. Each vertical bar indicates the number of commands that required a particular amount of time to service, as shown from 0 to Y. The drive 100 may service one command much faster than another of the same size for many reasons, such as the location of a data block on the drive relative to a previous head position, the number of retries that were necessary to satisfactorily read or write the data block, and the amount of cache available at the time the data block for the command must be serviced.

As can be seen, various modes have different maximum allowable service times as indicated by the vertical dashed lines representing thresholds for acceptable performance. For each bar of the histogram beyond the dashed line of the given mode, the drive 100 has performed unsatisfactorily in worst-case mode for the number of blocks as determined by the height of the bar and will receive negatively weighted points scaled by the number of blocks. For each bar not beyond the dashed line of the desired mode, the drive 100 has exceeded its worst-case performance requirements and will receive positively weighted points scaled by the number of blocks. As mentioned, the negative points may be weighted more heavily and therefore, the drive must have more bar area that is not beyond the threshold to cancel a lesser amount of bar area beyond the threshold.

As mentioned, the data handling system may be a computer network incorporating a streaming Internet connection having retry capabilities or a voice-over internet protocol network. In this embodiment, the performance characterization system typically measures the network's ability to parse commands for data transmission and make circuit-switching and packet routing decisions. The block service times that may be measured may include these parsing and decision-making times as well as the round-trip propagation delays for requests for re-transmission and for the propagation of the requested data.

The performance characterization system may also estimate parameters such as the minimum and maximum sustainable data rates and the time delay for a given data block resulting from the propagation of the command in one direction and the propagation of the retried data in the other direction. The parsing and decision-making time may be predicted from the estimate of the minimum and maximum sustainable data rates as well as the time delay for a given data block.

The performance characterization system may again treat data quality errors as good data delivered after the threshold. The commands may be such that the network is configured to emphasize throughput over quality, quality over throughput, or use a variable quality to maximize throughput and quality. The size of data quality errors may be measured, and the frequency of the data quality errors may be recorded.

Again, large data blocks may be requested to avoid caching schemes. Performance for smaller blocks, and for various modes may be determined by shifting time labels on resulting histograms and/or adjusting maximum allowable block service times as discussed for the disc drive implementation.

In conclusion, the invention may be viewed as a method (such as 152) for characterizing performance of a data handling system having a cache. The method involves sending commands to the data handling system for a set of data blocks that are large relative to a size of the cache dedicated for the commands (such as in operation 153). A block service time for each large data block is recorded (such as in operation 154). The block service time is compared to a first threshold (such as in operations 156 and 158). The data handling system is scored based on the comparison of the block service time to the first threshold (such as in operation 160).

The data handling system may include a disc drive (such as 100). The commands from the sending step may be configured to cause the disc drive to parse the command, seek to an appropriate track on a disc (such as 108) of the disc drive, wait for an appropriate location on the disc, track-follow on the appropriate track, and pass data between a buffer of the disc drive and the disc and between the buffer and a host computer (such as host computer 140) interfaced with the disc drive. The data handling system may include a computer network, and the commands from the sending step are configured to cause one or more networked computers to parse the command, transmit a request for re-transmission over the network, and receive retried data transmitted over the network.

The data blocks indicated by the commands sent by the method (such as 152) may be randomly positioned. The scoring step may include heavily and negatively weighting the block service times exceeding the first threshold, lightly and positively weighting the block service times not exceeding the first threshold, and averaging the weighted block service times (such as in operation 160). The method (such as 152) may also include recording the size of data quality errors produced in response to the commands (such as in operation 154), recording the frequency of data quality errors produced in response to the commands (such as in operation 154), and accounting for the size and frequency of data quality errors in the scoring step (such as in operation 160).

The method (such as 152) may involve estimating the minimum and maximum sustained data rates from the recorded block service times (such as in operation 154). The data handling system may include a disc drive (such as 100), and the method (such as 152) may include estimating the locations of data on a disc of the disc drive from the recorded block service times and corresponding commands (such as in operation 154), and determining a fraction of the drive that allows block service times to not exceed the first threshold from the estimated locations and corresponding block service times (such as in operations 156 and 158).

The method (such as 152) may also involve computing a second threshold for a mode that varies from a mode corresponding to the first threshold (such as in operation 164), comparing the block service time to the second threshold (such as in operations 156 and 158), and scoring the data handling system for the second mode based on the comparison of the block service time to the second threshold (such as in operation 160). The method may involve computing a third threshold for an alternate block size that varies from a size of the data blocks of the sending step, comparing the block service time to the third threshold, and scoring the data handling system for the alternate block size based on the comparison of the block service time to the third threshold (such as in operation 160). In the method, the sending step may involve sending commands that prioritize throughput over data quality (such as in operation 153).

The present invention may also be viewed as a system (such as 151) for characterizing performance of a data handling system (such as 100) having a cache (such as 144). The performance characterization system includes a host computer (such as 140) for providing commands that are serviced by the data handling system. The host computer is configured to send commands to the data handling system for a set of data blocks that are large relative to a size of the cache dedicated for the commands, record a block service time for each large data block, compare the block service time to a first threshold, and score the data handling system based on the comparison of the block service time to the first threshold. The performance characterization system also includes an interface (such as 144) for communicating the commands from the host computer to the data handling system.

The data handling system being characterized may include a disc drive (such as 100) and the commands from the system (such as 151) for characterizing performance are configured to cause the disc drive to parse the command, seek to an appropriate track on a disc of the disc drive, wait for an appropriate location on the disc (such as 108), track-follow on the appropriate 5 track, and pass data between a buffer (such as 144) of the disc drive and the disc and between the buffer and a host computer interfaced with the disc drive. The data handling system being characterized may include a computer network and the commands from the system for characterizing performance are configured to cause one or more networked computers to parse the command, transmit a request for re-transmission over the network, and receive retried data transmitted over the network.

The data blocks in the commands from the performance characterization system (such as 151) may be randomly positioned. The host (such as 140) may be configured to heavily and negatively weight the block service times exceeding the first threshold, lightly and positively weight the block service times not exceeding the first threshold, and averaging the weighted block service times. The host may be configured to record the size of data quality errors produced in response to the commands, record the frequency of data quality errors produced in response to the commands, and account for the size and frequency of data quality errors when scoring the data handling system. The host may be configured to estimate the minimum and maximum sustained data rates from the recorded block service times. The data handling system may include a disc drive (such as 100), and the host may be configured to estimate the locations of data on a disc (such as 108) of the disc drive from the recorded block service times and corresponding commands and determine a fraction of the drive that allows block service times to not exceed the first threshold from the estimated locations and corresponding block service times.

The host (such as 140) for the performance characterization system (such as 151) may be configured to compute a second threshold for a mode that varies from a mode corresponding to the first threshold, compare the block service time to the second threshold, and score the data handling system for the second mode based on the comparison of the block service time to the second threshold. The host may be configured to compute a third threshold for an alternate block size that varies from a size of the data blocks corresponding to the commands, compare the block service time to the third threshold, and score the data handling system for the alternate block size based on the comparison of the block service time to the third threshold. The host may be configured to send commands that prioritize throughput over data quality.

The host computer (such as 140) for the performance characterization system (such as 151) may be configured to adjust each recorded block service time prior to comparison of the block service times to the third threshold such that different amounts of time are subtracted from each block service time to account for the alternative block size based on the estimate of the minimum and maximum sustained data rates.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the performance characterizing system can be applied to various data handling systems such as disc drives or computer networks. The system may be applied such that all tasks possible for servicing commands are included in the block service time, or only certain tasks of interest. Other forms of analysis besides histogram processing may be utilized. Numerous other changes may be made which will readily suggest themselves to those skilled in the art and which are encompassed in the spirit of the invention disclosed and as defined in the appended claims.

What is claimed is:

1. A method for characterizing performance of a data handling system having a cache, comprising steps of:
a) sending commands to the data handling system for a set of data blocks that are large relative to a size of the cache dedicated for the commands;
b) recording a block service time for each large data block;
c) comparing the block service time to a first threshold;
d) scoring the data handling system based on the comparison of the block service time to the first threshold.

2. The method of claim 1, wherein the data handling system includes a disc drive.

3. The method of claim 2, wherein the commands from the sending step a) are configured to cause the disc drive to parse the command, seek to an appropriate track on a disc of the disc drive, wait for an appropriate location on the disc, track-follow on the appropriate track, and pass data between a buffer of the disc drive and the disc and between the buffer and a host computer interfaced with the disc drive.

4. The method of claim 1, wherein the data handling system includes a computer network and the commands from the sending step a) are configured to cause one or more networked computers to parse the command, transmit a request for re-transmission over the network, and receive retried data transmitted over the network.

5. The method of claim 1, wherein the data blocks are randomly positioned.

6. The method of claim 1, wherein the scoring step d) comprises:
d)(i) heavily and negatively weighting the block service times exceeding the first threshold;
d)(ii) lightly and positively weighting the block service times not exceeding the first threshold; and
d)(iii) averaging the weighted block service times.

7. The method of claim 1, further comprising steps of:
e) recording the size of data quality errors produced in response to the commands;
f) recording the frequency of data quality errors produced in response to the commands; and
g) accounting for the size and frequency of data quality errors in scoring step d).

8. The method of claim 1, further comprising steps of:
h) estimating the minimum and maximum sustained data rates from the recorded block service times.

9. The method of claim 1, wherein the data handling system includes a disc drive, the method further comprising steps of:
i) estimating the locations of data on a disc of the disc drive from the recorded block service times and corresponding commands; and
j) determining a fraction of the drive that allows block service times to not exceed the first threshold from the estimated locations and corresponding block service times.

10. The method of claim 1, further comprising steps of:
k) computing a second threshold for a mode that varies from a mode corresponding to the first threshold;
l) comparing the block service time to the second threshold; and
m) scoring the data handling system for the second mode based on the comparison of the block service time to the second threshold.

11. The method of claim 1, further comprising steps of:
n) computing a third threshold for an alternate block size that varies from a size of the data blocks of sending step a);
o) comparing the block service time to the third threshold; and
p) scoring the data handling system for the alternate block size based on the comparison of the block service time to the third threshold.

12. The method of claim 1, wherein the sending step a) further comprises sending commands that prioritize throughput over data quality.

13. A system for characterizing performance of a data handling system having a cache, comprising:
a host computer for providing commands that are serviced by the data handling system, the host computer configured to send commands to the data handling system for a set of data blocks that are large relative to a size of the cache dedicated for the commands, record a block service time for each large data block, compare the block service time to a first threshold, and score the data handling system based on the comparison of the block service time to the first threshold; and
an interface for communicating the commands from the host computer to the data handling system.

14. The performance characterization system of claim 13, wherein the data handling system includes a disc drive and the commands from the system for characterizing performance are configured to cause the disc drive to parse the command, seek to an appropriate track on a disc of the disc drive, wait for an appropriate location on the disc, track-follow on the appropriate track, and pass data between a buffer of the disc drive and the disc and between the buffer and a host computer interfaced with the disc drive.

15. The performance characterization system of claim 13, wherein the data handling system includes a computer network and the commands from the system for characterizing performance are configured to cause one or more networked computers to parse the command, transmit a request for re-transmission over the network, and receive retried data transmitted over the network.

16. The performance characterization system of claim 13, wherein the data blocks are randomly positioned.

17. The performance characterization system of claim 13, wherein the host computer is further configured to record the size of data quality errors produced in response to the commands, record the frequency of data quality errors produced in response to the commands, and account for the size and frequency of data quality errors when scoring the data handling system.

18. The performance characterization system of claim 13, wherein the host computer is further configured to compute a second threshold for a mode that varies from a mode corresponding to the first threshold, compare the block service time to the second threshold, and score the data handling system for the second mode based on the comparison of the block service time to the second threshold.

19. The performance characterization system of claim 13, wherein the host computer is further configured to estimate a minimum and maximum sustained data rate from the recorded block service times, compute a third threshold for an alternate block size that varies from a size of the data blocks corresponding to the commands, adjust each recorded block service time such that different amounts of time are subtracted from each block service time to account for the alternative block size based on the estimate of the minimum and maximum sustained data rates, compare the adjusted block service times to the third threshold, and score the data handling system for the alternate block size based on the comparison of the adjusted block service times to the third threshold.

20. A system for characterizing the performance of a data handling system, comprising:
an interface; and
a processing means for communicating commands through the interface to the data handling system and for scoring the data handling system based on the response to the commands.
